(19) United States
(12) Patent Application Publication
(10) Pub. No.: US 2006/0192440 A1
(43) Pub. Date: Aug. 31, 2006

(54) Synchronous motor, particularly for an aquarium pump

(75) Inventors: Axel Tunze, Penzberg (DE); Claude Hug, Horbourg Whir (FR)

Correspondence Address: YOUNG & BASILE, P.C., 3001 WEST BIG BEAVER ROAD, SUITE 624, TROY, MI, 48084, US

(73) Assignee: Tunze Aquarientechnik GmbH, Penzberg (DE)

(21) Appl. No.: 11/358,190

(22) Filed: Feb. 20, 2006

(30) Foreign Application Priority Data
Feb. 28, 2005 (DE) 10 2005 008 965.8

(51) Int. Cl. H02N 3/00

(52) U.S. Cl. 310/10

(57) ABSTRACT

In a propeller pump for an aquarium, starting-up of the rotor in the correct direction of rotation is guaranteed through the fact that a unit, which is formed by the propeller and the rotor of the pump, is disposed on a spindle in an axially displaceable and rotatable manner. If starting-up occurs in the wrong direction, said unit, and thereby the rotor, is drawn axially out of the magnetic field of the stator until the magnetic coupling between said stator and said rotor is no longer sufficient for further driving in the angular direction. The unit formed by the rotor and the propeller is then drawn back into the stator again by axial magnetic components of force, where a fresh opportunity of starting up again is imparted to it. It is guaranteed that the rotor will revolve in the correct direction after, at the latest, a few attempts at starting up.

### BACKGROUND OF THE INVENTION

The invention relates to a synchronous motor, particularly for an aquarium pump.

Synchronous motors are generally used for applications in which a motor construction which is robust and unsusceptible to breakdowns, and also quiet running of the motor, is important. Driving motors for aquarium pumps constitute a typical field of use for such motors.

It is known that, in synchronous motors, the direction in which the motor starts up from standstill is not easily predetermined. When the supply voltage is applied, the motor may start up in one or the other direction, depending upon the location of the rotor relative to the stator. For applications in which it is necessary for the motor to start up in a certain direction of rotation, mechanical starting devices are known which impart to the rotor, for example, a small initial movement in the correct direction of rotation. Such starting devices, which are known from synchronous clocks, may be driving levers which operate, via a ratchet transmission, on a gear wheel connected to the rotor.

However, mechanical starting devices of this kind are susceptible to breakdowns and are also unsuitable for use under conditions in which contamination by dirt has to be taken into account, such as in aquaria for example.

### SUMMARY OF THE INVENTION

The present invention is therefore intended to indicate a synchronous motor with a starting device which has a mechanically simple construction and is also suitable for use under environmental conditions which lead to contamination by dirt.

This object is achieved, according to the invention, by means of a synchronous motor having a stator and a rotor and also a starting device which guarantees that said rotor will start up in a predetermined direction of rotation, characterised in that the rotor is mounted in an axially movable manner and cooperates with a screwing-thrusting device which moves it away from the stator if it runs in the wrong direction of rotation.

In the synchronous motor according to the invention, the rotor is drawn out of the stator in the axial direction if it starts up in the wrong direction. This drawing-out operation continues until the magnetic coupling between the stator and rotor has become so weak that the rotor can no longer be kept in motion by the magnetic field. This axial distance may be slightly smaller or larger, depending upon whether the rotor is operating against a larger or smaller load.

When the rotor has come to a standstill, it is drawn back into the magnetic field of the stator again by axial components of the magnetic field acting upon it. This backward movement takes place in a manner unsynchronised with the magnetic field, so that there is a chance that, in the case of that relative position, angle-wise, between the rotor and the stator which exists when the magnetic coupling between the stator and rotor is once again sufficient for driving in the angular direction, said relative position will be one in which starting-up occurs in the correct direction of rotation. Should this not be the case, the rotor is once again removed from the stator in the axial direction and the cycle described above is repeated. This ensures that the rotor runs in the correct direction, if necessary, after a number of failed attempts.

At the same time, the synchronous motor according to the invention has a very simple construction, mechanically speaking. It has no mechanically complicated parts whose functioning might easily be impaired by contaminants, such as are found in aquarium water.

The development of the invention, wherein the rotor has a bearing bore by means of which it runs on a stationary spindle in a displaceable manner guarantees, in a simple manner, a low-friction mounting arrangement for the rotor, which arrangement is also self-cleaning in the course of the axial displacement of the rotor, which occurs at intervals, and the resumed rotational movement of the rotor on the spindle.

A propeller wheel, which is provided in any case for fluid-conveying purposes, is used for generating the axial power for the axial displacement of the rotor in the case of a wrong starting-up direction. A pump wherein the screwing-thrusting device has a propeller which is coupled, rotationwise, to the rotor thus differs from a normal propeller pump only through the fact that the rotor, and the propeller connected to the latter, are mounted so as to be axially movable on a spindle, and not in an axially rigid manner. This involves virtually no additional costs.

The development of the invention wherein the rotor is inserted in a hub section of the propeller makes it possible to design the rotor and propeller as a one-piece component. This facilitates assembly and lowers the manufacturing costs, particularly if the rotor is injection-molded directly into a plastic propeller. When the unit formed by the propeller and the rotor is manufactured in this way, accurate centering of the two parts on a common spindle is also automatically guaranteed. As a result of this, imbalances are largely avoided without any mechanical finishing.

The development of the invention, wherein the screwing-thrusting device comprises a threaded connection between the rotor and a motor shaft, is suitable for applications in which the synchronous motor is used for driving a mechanical load. According to this development, the axial relative movement is provided for by a screwing-thrusting device which allows a relative movement, axially and angle-wise, between the rotor and the driven shaft.

This device may be formed by a threaded connection, wherein the threaded connection includes a course thread, the steepness of the thread ensuring that the driving movement is interrupted after even a small starting-up travel, angle-wise, in the wrong direction of rotation.

The development of the invention wherein the threaded connection comprises a threaded rib which is connected to the rotor, and a threaded sleeve which is connected to the motor shaft, or vice versa, guarantees that the screwing-thrusting device is well protected against contamination by dirt, since the cooperating screw faces are located in the interior of a sleeve.

The development of the invention wherein a stop device which limits the axial path of adjustment of the rotor away toward the stator guarantees that, when an external force is exerted on the propeller, or on a shaft connected to a load, the rotor cannot be removed very far from the stator axially, that is to say does not reach a distance from said stator at which the axially acting forces between the stator and rotor would no longer be sufficient to draw the rotor back to the stator again. In this way, it is then possible to do without a separate rotor-restoring device which presses the rotor back to the stator in the axial direction.

Choosing the stop device wherein the stop device limits the axial path of adjustment of the rotor to a distance which amounts to between 30% and 70%, and preferably about 45% of the maximum axial magnetic overlap between the rotor and the stator, on the one hand ensures that, in the axially extended position, the rotor is magnetically uncoupled from the stator to an extent such that it is moved back into said stator at a different position relative to the stator, angle-wise. What is also ensured, on the other hand, is that the magnetic restoring forces which act in the axial direction are still sufficiently great.

In the case of applications in which, because of increased friction or for other reasons connected with design, it is not possible to ensure that the axial magnetic forces are sufficient for drawing the rotor back into the stator, a separate restoring device may be provided, wherein a retensioning device by which the rotor is pretensioned into a location which is in axial alignment with the stator in order to move the rotor back into the stator.

### BRIEF DESCRIPTION OF THE DRAWINGS

Exemplified embodiments of the invention will be explained in greater detail below with reference to the drawings, in which:

FIG. 1 shows an axial section through a propeller pump for an aquarium, which pump contains a synchronous motor, when said pump is running in the correct way;

FIG. 2 shows a similar section to that in FIG. 1, in which, however, the rotor is shown in a position which is obtained when the rotor starts up in the wrong direction;

FIG. 3 shows a similar view to that in FIG. 1, in which, however, the synchronous motor serves to drive a motor shaft which can be coupled to a mechanical load, the rotor being represented in that axial position which it assumes after starting up in the correct direction of rotation; and

FIG. 4 shows a view similar to that in FIG. 3, in which, however, the rotor is represented in that axial position which it assumes after starting up in the wrong direction of rotation.

### DETAILED DESCRIPTION OF THE PREFERRED EMBODIMENT

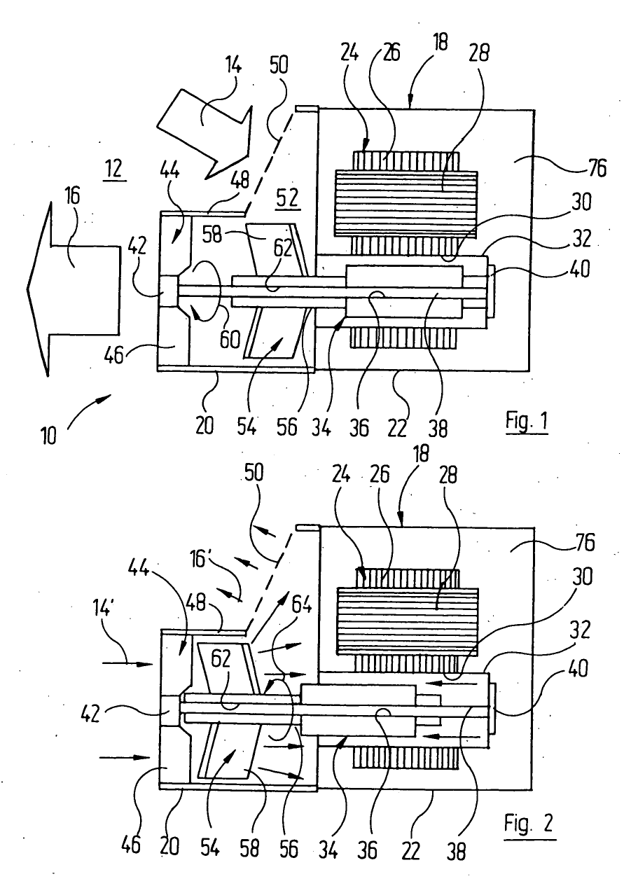

A propeller pump which is disposed in a volume 12 of aquarium water which is illustrated only diagrammatically, is designated as a whole by 10 in FIG. 1. Said propeller pump 10 sucks water out of the volume of water 12 in the direction indicated by an arrow 14 and gives the water off into the aquarium again in a direction which is indicated by an arrow 16.

The propeller pump 10 has a housing which is designated as a whole by 18 and which is subdivided into a pump housing 20 and a motor housing 22.

Disposed in said motor housing 22 is a stator 24 which has a set of laminations 26 and an excitation coil 28.

The set of laminations 26 has a bore 30 which holds a separating cup 32. Disposed in said separating cup 32, with radial clearance, is a rotor 34 which is manufactured from permanently magnetic material which may have, for example, a plurality of poles distributed in the peripheral direction.

If the excitation coil 28 is acted upon by a signal from an external source of alternating voltage which is not represented, the rotor 34 begins to rotate within the alternating magnetic field.

Said rotor 34 has a central bore 36, which is seated rotatably on a spindle 38.

At one end, said spindle 38 has an end flange 40 which rests on the outer side of the bottom of the separating cup 32, said spindle 38 passing through a central bore in said separating cup 32.

The second end of the spindle 38 is mounted in a hub section 42 of a mounting star 44 which is fixedly connected, via radial arms 46, to an outlet nozzle 48 which is formed by a molded-on section of the pump housing 20.

In a section of transition to the motor housing 22, which section is similar to a partial cone, the pump housing 20 also has an inlet screen 50 which is manufactured in conjunction with the injection-molding of the pump housing 20.

Said pump housing 20 thus presupposes a working space 52 which lies between the inlet screen 50 and the outlet nozzle 48 and within which a propeller, which is designated as a whole by 54, revolves. Said propeller 54 has a hub section 56 which carries three blades 58 which are inclined in relation to the propeller spindle. The inclination of the blades 58 is so arranged that, when the propeller 54 revolves in the correct direction of rotation indicated by an arrow 60, water is sucked in through the inlet screen 50 and given off through the outlet nozzle 48.

As can be seen from FIG. 1, the rotor 34 is inserted in the hub section 56. This insertion expediently takes place through the fact that the rotor 34, which is already provided with the bore 36, is laid in an injection mold by means of which the propeller 54, which consists of thermoplastic material, is injection-molded. In this way, exact alignment of a central bore 62 in the propeller 54 with the central bore 36 in the rotor is guaranteed.

Moreover, that part of the hub section 56 which is situated on the right in the drawings may serve as a distance piece which predetermines that axial position of the rotor 34 which is retracted into the separating cup to the maximum extent. Conversely, that end face of the hub section 56 which is situated on the left in the drawings may predetermine, in conjunction with the hub section 42 of the outlet star 44, that axial position of the rotor 34 which is extended to the maximum extent.

As can be seen from FIG. 1, in the position in which it is retracted to the maximum extent, the rotor 34 lies symmetrically in relation to the central plane of the stator.

As has already been explained, the entire unit formed by the rotor 34 and the propeller 54 is disposed, not only rotatably but also in an axially displaceable manner on the spindle 38.

When the propeller pump 10 is working, with the rotor 34 and the propeller 54 revolving in the direction of the arrow 60, a force which is directed towards the right in FIG. 1 is maintained on the unit formed by said rotor 34 and propeller 54, as a force of reaction to the impartation of momentum to the water. Said force is absorbed by the axial bearing or the stop device for inward movement which is formed by the right-hand end face of the hub section 56 and the bottom of the separating cup 32.

When the rotor movement is rotating in the correct direction, the rotor thus has a predetermined axial position and runs just like a rotor which is mounted via an axial/radial bearing.

If, on the other hand, the rotor 34 runs, when the excitation coil 28 is acted upon by voltage, in the wrong direction of rotation, as is indicated by an arrow 64 in FIG. 2, the propeller 54 sucks water in via the outlet star 44 and forces it back into the aquarium through the inlet screen 50. There is now obtained, as a force of reaction with respect to the momentum imparted to the water, an axial force on the unit formed by the rotor 34 and propeller 54, which force extends in the outward axial direction, as a result of which the unit formed by the rotor 34 and the propeller 54 is moved towards the left in FIG. 2.

This leftward movement ends when the magnetic coupling between the stator 24 and rotor 34 has become so weak that it is no longer sufficient to turn the propeller 54 against the load constituted by the water. Under these conditions, there is no longer any synchronisation, angle-wise, between the rotor 34 and the alternating magnetic field. However, there remain axial components of the magnetic field which attempt to draw the rotor 34 back into the separating cup 32 in the axial direction.

In the course of this rearward movement, the magnetic coupling between the stator 24 and rotor 34 is then reinforced again, it being purely a matter of chance whether said coupling then once again reaches a level which is sufficient for driving purposes when the rotor is in a position, relative to the stator, which is favorable for starting up in the correct direction, or not.

If the relative position between the rotor and stator is that which is favorable for starting up in the correct direction of rotation, the rotor starts up in the correct direction and is moved back into full magnetic overlap with the stator again by the force of reaction which is now directed towards the right in FIGS. 1 and 2, the end face of the hub section 56 of the propeller 54 coming to rest against the bottom wall of the separating cup 32.

In the course of this axial resetting of the rotor 34 into the magnetic field of the stator 24, the flow against the blades 58 of the propeller 54 brings about a slight rotation of the rotor 34 in the opposite direction to the direction of rotation in which it had started up before, that is to say in the correct direction of rotation. This may increase the chance of the rotor 34 starting up in the correct direction of rotation when the magnetic coupling between the stator 24 and rotor 34 is reestablished to an extent such that a driving torque is obtained.

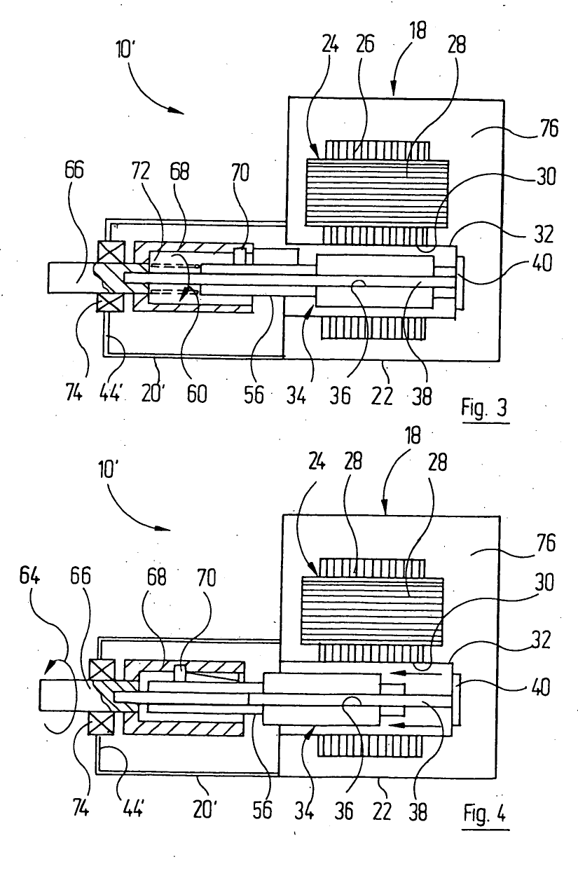

In the exemplified embodiment according to FIGS. 3 and 4, parts of a motor designated, as a whole, by 10′ which correspond to components of the propeller pump 10 which have already been described above, are once again provided with the same reference symbols.

A motor shaft 66, which carries a threaded sleeve 68 at its end that faces towards the rotor, is now mounted in a bearing wall 44′ belonging to the housing part 20′. Said threaded sleeve is provided, on its inner face, with a coarse-thread groove.

The coarse-thread groove in the threaded sleeve 68 cooperates with a coarse-thread rib 70 which is injection-molded onto the outer face of the hub section 56.

As regards starting up, the motor 10′ shown in FIGS. 3 and 4 works in a similar manner to the propeller pump 10 described above. However, a screwing-thrusting device which converts a rotational movement of the rotor in the wrong direction of rotation into an axial outward movement of said rotor is formed, not by a propeller 54 which carries inclined blades 58 and cooperates with a volume of water constituting a load, but by a screwing-thrusting transmission which is formed by the threaded sleeve 68 and the coarse-thread rib 70. In the case of said transmission, a load which is connected to the motor shaft 66 brakes the threaded sleeve 68 with respect to the coarse-thread rib 70, as a result of which the screwing-slip which generates the desired axial force is obtained.

If the motor runs in the correct direction of rotation, a predetermined relative axial position between the rotor 34 and the motor shaft 66 is obtained, and thereby a torque-locking connection between said two parts.

If, on the other hand, the rotor 34 runs in the wrong direction, the hub section 56 is subjected to screwing, by means of its coarse-thread rib 70, on the threaded sleeve 68, which is braked by a load connected to the motor shaft 66. The rotor 34 is thereby drawn out of the magnetic field of the stator 24 to an extent such that the movement of the rotor is terminated and said rotor is then drawn back into the stator and is able to start up afresh in the correct direction of rotation, as described above.

In order to guarantee a stronger restoring force, in the event of the magnetic restoring forces obtained in that position of the rotor 54 which is axially remote from the stator 24 being insufficient to draw the rotor 34 back to the stator 24, it is possible to provide a restoring spring 72 which is designed as a helical spring and is disposed between the mutually opposed end faces of the hub section 56 and the bearing wall 44.

In order to guarantee that the motor will be satisfactorily unsusceptible to the influence of moisture, the interior of the motor housing 22 may be filled up with a sealing compound 76.

What is claimed is:

1. A synchronous motor, particularly for an aquarium pump, said motor having a stator and a rotor and also a starting device which guarantees that said rotor will start up in a predetermined direction of rotation, characterized in that the rotor is mounted in an axially movable manner and cooperates with a screwing-thrusting device which moves the rotor away from the stator if the rotor runs in the wrong direction of rotation.

2. The synchronous motor according to claim 1, characterized in that the rotor has a bearing bore by means of which the rotor runs on a stationary spindle in a displaceable manner.

3. The synchronous motor according to claim 1, characterized in that the screwing-thrusting device has a propeller which is coupled, rotation-wise, to the rotor.

4. The synchronous motor according to claim 3, characterized in that the rotor is inserted in a hub section of the propeller.

5. The synchronous motor according to claim 1, characterized in that the screwing-thrusting device comprises a threaded connection between the rotor and a motor shaft.

6. The synchronous motor according to claim 5, characterized in that the threaded connection comprises a coarse thread.

7. The synchronous motor according to claim 5, characterized in that the threaded connection comprises a threaded rib which is connected to the rotor, and a threaded sleeve which is connected to the motor shaft, or vice versa.

8. The synchronous motor according to claim 1, characterized by a stop device which limits the axial path of adjustment of the rotor away towards the stator.

9. The synchronous motor according to claim 8, characterized in that the stop device limits the axial path of adjustment of the rotor to a distance which amounts to between 30% and 70%, and preferably about 45%, of the maximum axial magnetic overlap between the rotor and the stator.

10. The synchronous motor according to claim 1, characterized by a retensioning device by which the rotor is pretensioned into a location which is in axial alignment with the stator.
